(19) United States
(12) Patent Application Publication
(10) Pub. No.: US 2022/0180232 A1
(43) Pub. Date: Jun. 9, 2022

(54) FORECASTING BASED ON BERNOULLI UNCERTAINTY CHARACTERIZATION

(71) Applicant: Intuit Inc., Mountain View, CA (US)

(72) Inventors: Sambarta Dasgupta, Sunnyvale, CA (US); Sricharan Kallur Palli Kumar, Mountain View, CA (US)

(73) Assignee: Intuit Inc., Mountain View, CA (US)

(21) Appl. No.: 17/115,297

(22) Filed: Dec. 8, 2020

(51) Int. Cl. G06N 7/00; G06N 20/00; G06F 16/25

(52) U.S. Cl. CPC G06N 7/005; G06F 16/25; G06F 16/258; G06N 20/00

(57) ABSTRACT

This disclosure relates to predictions based on a Bernoulli uncertainty characterization used in selecting between different prediction models. An example system is configured to perform operations including determining a prediction by a first prediction model. The first prediction model is associated with a loss function. The system is also configured to determine whether the prediction is associated with the first prediction model or a second prediction model based on a joint loss function. The second prediction model is associated with a likelihood function, and the joint loss function is based on the loss function and the likelihood function. The system is further configured to indicate the prediction to the user in response to determining that the prediction is associated with the first prediction model. If the prediction is associated with the second prediction model, the system may prevent indicating the prediction to the user.

### TECHNICAL FIELD

This disclosure relates generally to systems for data prediction based on a Bernoulli uncertainty characterization used in selecting between different prediction models to generate the prediction.

### DESCRIPTION OF RELATED ART

Various computer implemented prediction models are used to forecast various data of interest to a user. For example, various prediction models are used to forecast real estate values, stock market or other asset prices, completion times for projects, and so on. Users may use one or more models to forecast cash flow, revenue, liquidity, and so on of a business from invoices, sales, expenses, and other business records. However, such models are not faultless. For example, on the off chance a computer system implementing a model indicates an inaccurate cash flow prediction to the user, the user may determine a business' future operations based on the inaccurate cash flow prediction.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter. Moreover, the systems, methods, and devices of this disclosure each have several innovative aspects, no single one of which is solely responsible for the desirable features disclosed herein.

One innovative aspect of the subject matter described in this disclosure can be implemented as a method for indicating a prediction to a user. An example method includes determining a prediction by a first prediction model. The first prediction model is associated with a loss function. The method also includes determining whether the prediction is associated with the first prediction model or a second prediction model based on a joint loss function. The second prediction model is associated with a likelihood function, and the joint loss function is based on the loss function and the likelihood function. The method further includes indicating the prediction to the user in response to determining that the prediction is associated with the first prediction model. If the prediction is associated with the second prediction model, the prediction may be prevented from being indicated to the user.

Another innovative aspect of the subject matter described in this disclosure can be implemented in a system for indicating a prediction to a user. In some implementations, the system includes one or more processors and a memory coupled to the one or more processors. The memory can store instructions that, when executed by the one or more processors, cause the system to perform operations including determining a prediction by a first prediction model. The first prediction model is associated with a loss function. The operations also include determining whether the prediction is associated with the first prediction model or a second prediction model based on a joint loss function. The second prediction model is associated with a likelihood function, and the joint loss function is based on the loss function and the likelihood function. The operations further include indicating the prediction to the user in response to determining that the prediction is associated with the first prediction model. If the prediction is associated with the second prediction model, the prediction may be prevented from being indicated to the user.

Another innovative aspect of the subject matter described in this disclosure can be implemented in a non-transitory, computer readable medium storing instructions that, when executed by one or more processors of a system for indicating a prediction to a user, cause the system to perform operations including determining a prediction by a first prediction model. The first prediction model is associated with a loss function. The operations also include determining whether the prediction is associated with the first prediction model or a second prediction model based on a joint loss function. The second prediction model is associated with a likelihood function, and the joint loss function is based on the loss function and the likelihood function. The operations further include indicating the prediction to the user in response to determining that the prediction is associated with the first prediction model. If the prediction is associated with the second prediction model, the prediction may be prevented from being indicated to the user.

### BRIEF DESCRIPTION OF THE DRAWINGS

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

FIG. 1 shows a block diagram of a system to indicate a prediction to a user, according to some implementations.

FIG. 2 shows an illustrative flowchart depicting an example operation for indicating a prediction to a user, according to some implementations.

FIG. 3 shows an illustrative flowchart depicting an example operation for training prediction models used in determining a prediction, according to some implementations.

Like reference numbers and designations in the various drawings indicate like elements.

### DETAILED DESCRIPTION

The following description is directed to certain implementations for determining and indicating a prediction to a user. The prediction may be determined based on a Bernoulli uncertainty characterization, with a Bernoulli variable used in selecting between different prediction models to generate the prediction. However, a person having ordinary skill in the art will readily recognize that the teachings herein can be applied in a multitude of different ways. It may be readily understood that certain aspects of the disclosed systems and methods can be arranged and combined in a wide variety of different configurations, all of which are contemplated herein.

A model may be trained to forecast cash flow or other business metrics. For example, a computer system may use the model to predict cash flow for one or more future points in time, and the system may indicate the predictions to a user. The user then directs future business decisions in light of the predictions. Since the user may direct future business decisions in light of the predictions, there is a need for the predictions used in directing business decisions to be accurate (such as more accurate than a simplistic model, including a guess based on a parametric distribution of possible predictions). Inaccurate predictions may negatively affect future business operations determined in light of the predictions. In addition, inaccurate predictions may cause the user to lose trust in the system or model.

In addition, a user may be interested only in predictions that diverge from what is expected. For example, when cash flow of a business is steady, a user may be interested in a predicted change in cash flow greater than a threshold that may significantly impact future business operations (such as a sudden loss or increase that may affect liquidity). As a result of the system constantly indicating the predictions to the user, the user is compelled to decipher which predictions are important and which are unimportant. Yet the sheer number of predictions and the vast amounts of business data influencing the predictions makes it impracticable for a user to determine which predictions are of interest within an acceptable amount of time (much less in real time).

As such, there is a need to prevent inaccurate predictions from being indicated to a user. There is also a need to filter which predictions are indicated to a user so that the user is apprised only of the predictions of interest.

In some implementations, a system can filter predictions to be indicated to a user to improve the accuracy of the predictions and the relevance of the predictions to the user. The system may use multiple prediction models to generate predictions, and the system may determine if and which predictions are to be indicated to the user based on which model to which a prediction is attributed. For example, the system may use a trained prediction model (such as a machine learning model or other suitable model) to generate a prediction, and the system then determines whether the prediction can just as easily be attributed to a control prediction model (which may be a simple prediction model defined by a parametric distribution or Quantile regression of the input data) instead of the trained prediction model. If the prediction is determined to be associated with the trained prediction model instead of the control prediction model (such as indicating that the prediction varies from the probability distribution associated with a simple prediction model), the system indicates the prediction to the user. If the trained model's prediction cannot be attributed to the trained model (indicating that the simple prediction model may be at least as effective in predicting than the trained model for that particular instance), the system prevents the trained model's prediction from being indicated to the user. In this manner, the system causes the predictions indicated to the user to be of more relevance and with a higher confidence or likelihood.

Various aspects of the present disclosure provide a unique computing solution to a unique computing problem that did not exist. More specifically, the problem of filtering computer generated predictions did not exist prior to the use of computer implemented models for prediction based on vast numbers of financial or other electronic commerce-related transaction records, and is therefore a problem rooted in and created by technological advances in businesses to accurately differentiate between inaccurate and accurate predictions and important and unimportant predictions.

As the number of transactions and records increases, the ability to identify and indicate predictions of importance (and thus be able to determine a plan of action based on the predictions) requires the computational power of modern processors and machine learning models to accurately identify such predictions, in real-time, so that appropriate action can be taken. Therefore, implementations of the subject matter disclosed herein are not an abstract idea such as organizing human activity or a mental process that can be performed in the human mind, for example, because it is not practical, if even possible, for a human mind to evaluate the transactions of thousands to millions, or more, at the same time to identify each prediction's accuracy and importance.

In the following description, numerous specific details are set forth such as examples of specific components, circuits, and processes to provide a thorough understanding of the present disclosure. The term “coupled” as used herein means connected directly to or connected through one or more intervening components or circuits. The terms “processing system” and “processing device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example implementations. In other instances, well-known circuits and devices are shown in block diagram form to avoid obscuring the present disclosure. Some portions of the detailed descriptions which follow are presented in terms of procedures, logic blocks, processing, and other symbolic representations of operations on data bits within a computer memory.

In the figures, a single block may be described as performing a function or functions. However, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example systems and devices may include components other than those shown, including well-known components such as a processor, memory, and the like.

Several aspects of prediction analysis and indicating predictions to a user for a business will now be presented with reference to various apparatus and methods. These apparatus and methods will be described in the following detailed description and illustrated in the accompanying drawings by various blocks, components, circuits, devices, processes, algorithms, and the like (collectively referred to herein as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

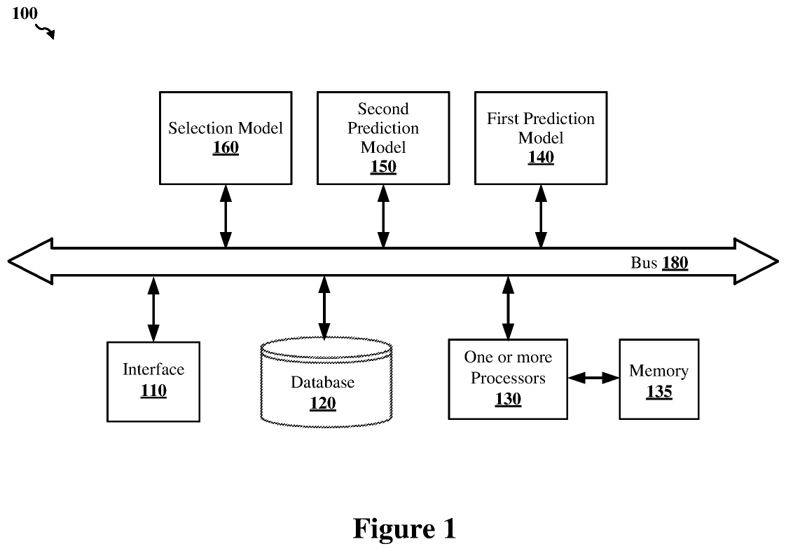

FIG. 1 shows a block diagram of a system 100 to indicate a prediction to a user, according to some implementations. Although described herein as predictions with respect to cash flow of a business, in some other implementations, the predictions may be with respect to revenue, invoice payments, asset prices, or any other suitable predictions that may or may not be business related. The system 100 is shown to include an input/output (I/O) interface 110, a database 120, one or more processors 130, a memory 135 coupled to the one or more processors 130, a first prediction model 140, a second prediction model 150, a selection model 160, and a data bus 180. The various components of the system 100 may be connected to one another by the data bus 180, as depicted in the example of FIG. 1. In other implementations, the various components of the system 100 may be connected to one another using other suitable signal routing resources.

The interface 110 may include any suitable devices or components to obtain information (such as input data) to the system 100 and/or to provide information (such as output data) from the system 100. In some instances, the interface 110 includes at least a display and an input device (such as a mouse and keyboard) that allows users to interface with the system 100 in a convenient manner. The interface 110 may indicate one or more predictions determined by one or more of the prediction models 140 and 150. Example indications may include a visual indication (such as indicating the prediction to a user via a display).

The input data includes data provided to the prediction models 140 and 150 to generate predictions. The input data may include training data to train the models 140-160 or data used for operation of the trained models to determine predictions to be indicate to a user. For example, if the prediction models predict cash flow of a business, example input data includes payments, invoices, or other known business activity. While the examples herein are described with reference to predicting cash flow, the system 100 may be configured to predict any suitable metric of interest to a user.

The input data is associated with a plurality of features and responses used in predicting future cash flow. Example features include transactions involving vendors, clients, or other entities that may influence the predictions. For example, features may include fees from an invoice collected from a client, fees paid to a vendor, taxes paid, or other measured transactions that may affect cash flow. Responses include changes to the cash flow based on the features. The notation of the feature-response pairs of the input data is (xᵢ,yᵢ) for integer i from 1 to N and xᵢ and yᵢ being real numbers. While the examples herein of input data, generating predictions, and indicating predictions to a user are provided in a univariate setting for clarity in explaining aspects of the present disclosure, the operations described herein may also be performed in a multivariate setting.

The database 120 can store any suitable information relating to the input data or the predictions. For example, the database 120 can store training data or operational data received via the interface 110, previous predictions, variable information or other information about the models 140-160, or other suitable information. In some instances, the database 120 can be a relational database capable of manipulating any number of various data sets using relational operators, and present one or more data sets and/or manipulations of the data sets to a user in tabular form. The database 120 can also use Structured Query Language (SQL) for querying and maintaining the database, and/or can store information relevant to the predictions in tabular form, either collectively in a table or individually for each prediction.

The one or more processors 130, which may be used for general data processing operations (such as transforming data stored in the database 120 into usable information), may be one or more suitable processors capable of executing scripts or instructions of one or more software programs stored in the system 100 (such as within the memory 135). The one or more processors 130 may be implemented with a general purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In one or more implementations, the one or more processors 130 may be implemented as a combination of computing devices (such as a combination of a DSP and a microprocessor, a plurality of microprocessors, one or more microprocessors in conjunction with a DSP core, or any other such configuration).

The memory 135 may be any suitable persistent memory (such as one or more nonvolatile memory elements, such as EPROM, EEPROM, Flash memory, a hard drive, etc.) that can store any number of software programs, executable instructions, machine code, algorithms, and the like that, when executed by the one or more processors 130, causes the system 100 to perform at least some of the operations described below with reference to one or more of the Figures. In some instances, the memory 135 can also store training data, seed data, and/or training data for the components 140-160.

The first prediction model 140 can be used to generate one or more predictions from the data obtained by the system 100. For example, the first prediction model 140 predicts one or more future data points in cash flow of a business. In some implementations, the first prediction model 140 is a machine learning model based on one or more of decision trees, random forests, logistic regression, nearest neighbors, classification trees, control flow graphs, support vector machines, naïve Bayes, Bayesian Networks, value sets, hidden Markov models, or neural networks configured to predict one or more data points from the input data. However, the first prediction model 140 may be any suitable prediction model (including user defined or supervised models). The first prediction model 140 is the primary prediction model 140 of the system 100. In this manner, the user is interested in the predictions from the first prediction model, and the system 100 may indicate the predictions from the first prediction model 140 to the user.

The second prediction model 150 is a prediction model to generate a second set of predictions. For example, the second prediction model 150 may be used in evaluating the predictions of the first prediction model 140. In some implementations, the second prediction model 150 is a predefined prediction model, such as a statistical model defined by a probability distribution. For example, the second prediction model 150 is a regression model based on a parametric distribution of noise in the input data (such as a Gaussian distribution, Poisson distribution, or other known distributions). For a Gaussian distribution including a mean and standard deviation, the mean and standard deviation define the second prediction model 150. However, any suitable distribution or model may be used. In another example, the probability distribution of the second prediction model 150 is based on quantiles (such as quantiles at 10 percent increments of confidence or any other suitable confidence intervals). The second prediction model 150 attempts to generate predictions from the same dataset used by the first prediction model 140 to generate predictions. In this manner, the predictions between the models 140 and 150 may be compared to each other. In one example, the second prediction model 150 may be considered a control model whose predictions are to be used in analyzing the predictions from the first prediction model 140. For example, if a prediction from the first prediction model 140 can be just as easily attributed to the second prediction model 150 than the first prediction model 140 (such as the prediction not varying by more than a tolerance from what the second prediction model 150 would predict), the system 100 may be configured to prevent indicating the prediction to the user. Such comparison and determination may be performed using the selection model 160. While the system 100 is depicted as including two prediction models, the system 100 may include any suitable number of prediction models (such as three or more prediction models). In this manner, predictions from one or more primary prediction models may be analyzed based on one or more other prediction models to determine if a prediction is to be indicated to the user.

The selection model 160 can be used to determine whether the prediction is to be indicated to the user. For example, the selection model 160 determines whether the prediction from the first prediction model 140 is more likely associated with the first prediction model 140 or with the second prediction model 150. Example implementations of the selection model 160 being used to determine whether to indicate the prediction to the user are described in the examples herein.

Each of the first prediction model 140, the second prediction model 150, and the selection model 160 may be incorporated in software (such as software stored in memory 135) and executed by one or more processors (such as the one or more processors 130), may be incorporated in hardware (such as one or more application specific integrated circuits (ASICs), or may be incorporated in a combination of hardware or software. For example, one or more of the models 140-160 may be coded using Python for execution by the one or more processors. In addition or to the alternative, one or more of the components 140-160 may be combined into a single component or may be split into additional components not shown. The particular architecture of the system 100 shown in FIG. 1 is but one example of a variety of different architectures within which aspects of the present disclosure may be implemented.

The system 100 (using the selection model 160) is configured to determine predictions from the first prediction model 140 as to be indicated to the user or prevented from being indicated to the user. Indicating the predictions to the user is based on a variance of the predictions from what the second prediction model would predict. In this manner, a prediction significantly varying from a second prediction model's output may be of interest to the user and is thus indicated to the user. A prediction not varying from the second prediction model's output (such as not varying from a Gaussian probability distribution or other parametric distribution attributed to noise) may not be of interest to the user and is thus prevented from being indicated to the user. Implementations of determining to which prediction model a prediction is associated are based on a Bernoulli variable (also referred to as a binary variable). As used herein, a Bernoulli variable is a variable with two discrete values (such as 0 or 1). The Bernoulli variable may be used in a joint loss function associated with both prediction models to evaluate the predictions. In the examples, the first prediction model is associated with the Bernoulli variable value equal to 1, and the second prediction model is associated with the Bernoulli variable value equal to 0. While the examples are provided for two prediction models, as noted above, the system 100 may include three or more prediction models. In this manner, the number of discrete values for the Bernoulli variable may be expanded from two to a multi-valued discrete distribution. In a different example, multiple Bernoulli variables that may be two discrete values may be combined to allow for three or more prediction models to be used. As such, the below examples of two prediction models are provided for clarity in explaining aspects of the present disclosure, but the scope of the present disclosure is not limited to only two prediction models.

Use of a joint loss function associated with the multiple prediction models allows for determining with greater accuracy if a specific prediction from the first prediction model 140 is associated with the first prediction model 140 over the second prediction model 150 (and thus be indicated to a user). In typical prediction systems, traditional Bayesian methods of determining a confidence based on a loss function includes adding a separate variable to the prediction model's loss function for a model uncertainty (such as noise). In this manner, the loss function includes a combination of a model uncertainty and an observation uncertainty, and as a result of the multiple uncertainties, typical methods of analyzing the loss function to determine a confidence for a specific data point (based on the observation uncertainty) becomes impossible.

In some implementations, the model uncertainty may also be modelled in a second prediction model. For example, if the data includes a Gaussian distribution of noise, the second prediction model may be based on a Gaussian distribution associated with a known likelihood function. In this manner, the loss function determined for the first prediction model and the likelihood function known for the second prediction model may be combined to generate a joint loss function associated with both prediction models. The loss function and the likelihood function both include the model uncertainty that may be used to isolate the observation uncertainty for determining a confidence in a prediction from the loss function. The determined confidence indicates an estimated likelihood of the prediction occurring.

In the following examples, the association of a prediction with a specific prediction model and the determination of a confidence is formulated in terms of a regression problem for time series data (such as predicting cash flow from input time series data for a business). For example, prediction of values may be characterized as a problem including auto-regressive delayed values in time series. Each prediction from the first prediction model 140 may not be assumed to be associated with a parametric probability distribution, but the totality of the predictions from the first prediction model 140 may be associated with a similar distribution as used to generate the second prediction model 150. The probability distribution of a second prediction model 150 may be a parametric probability distribution (such as Gaussian, Log-Normal, Poisson, and so on) or not a parametric probability distribution (such as based on Quantile regression). In the specific examples provided below for clarity, the second prediction model 150 is defined by a Gaussian probability distribution A Gaussian probability distribution is used to explain the associated likelihood function and joint loss functions with specificity in the examples. In this manner, the input data (xᵢ,yᵢ) is associated with a regression model parameterized by w. However, any suitable prediction model may be used as a control prediction model.

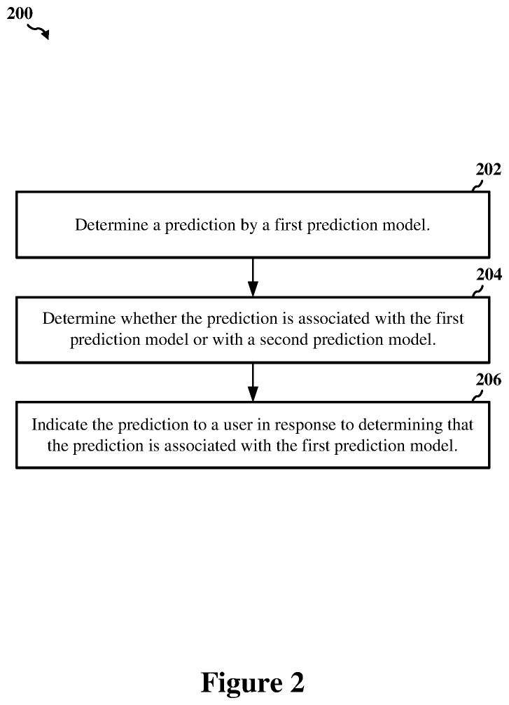

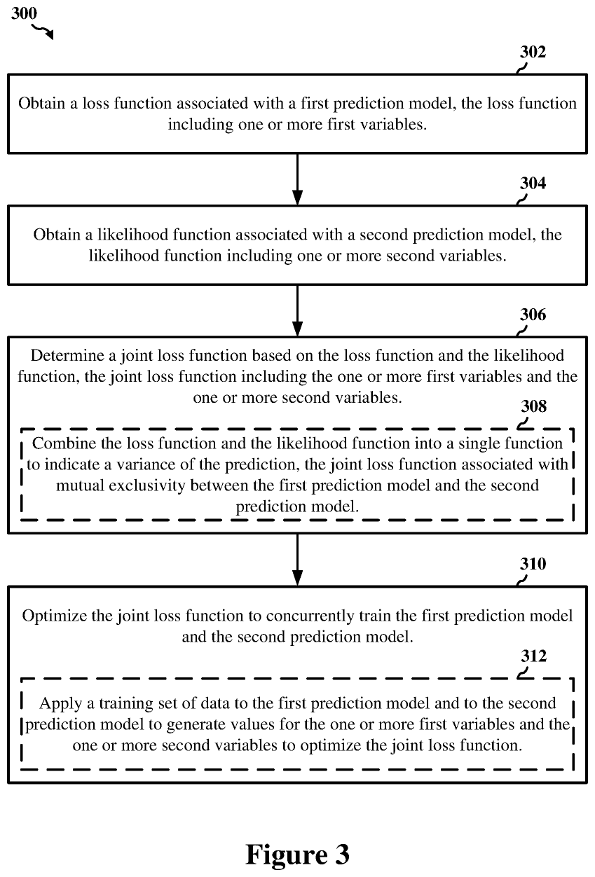

The predicted probability distribution p(ŷᵢ|w,xᵢ,zᵢ=1) for the first prediction model (with zᵢ being the Bernoulli variable with values 0 (for the second prediction model) and 1 (for the first prediction model)) can be represented by a parametric distribution associated with the second prediction model (in this instance, a Gaussian distribution). Under the assumption of a Gaussian distribution, the probability distribution can be represented by a mean (noted as a vector of mean values over the training data; μᵢ(w)∈ [symbol] ⁿ) and a standard deviation (noted as a vector of standard deviation values over the training data; σᵢ(w)∈ [symbol] ⁿ). In this manner, each prediction may be associated with a different mean and standard deviation. The predicted probability distribution (ŷᵢ|w,xᵢ,zᵢ=0) for the second prediction model based on a Gaussian distribution is defined as a mean (μ̅∈ [symbol] ) and standard deviation (σ̅∈ [symbol] ) of the training data, which may be determined from the group of feature-response pairs of the input data. In the example, the second prediction model is a low variance naïve prediction model comprised of the mean and standard deviation of the training data. However, any suitable prediction model may be used as the second prediction model. zᵢ(w,x₁)∈{0,1} is the Bernoulli variable which is used to determine if a prediction is associated with the first prediction model 140 or the second prediction model 150. As noted above, if more than two prediction models are used, the Bernoulli variable may be a distribution of more than two discrete values based on the number of prediction models. The probability of the first prediction model being selected (p(zᵢ=1|w,xᵢ)) is also noted as θᵢ(w,xᵢ). If zᵢ is binary, the probability of the second prediction model being selected (p(zᵢ=0|w,xᵢ)) is defined as 1−θᵢ(w,xᵢ) since the sum of the two probabilities equals 1. In this manner, a portion of each prediction from the first prediction model is associated with some representation of p(zᵢ=0|w,xᵢ). The larger the portion attributed to such representation, the less likely the prediction is associated with the first prediction model 140 (as the second prediction model 150 may be just as effective in providing such prediction). Details of the joint loss function, determining a prediction's association based on the joint loss function, and use of a Bernoulli variable in the joint loss function for determining whether to indicate a prediction to a user are described below with reference to FIGS. 2 and 3.

FIG. 2 shows an illustrative flowchart depicting an example operation 200 for indicating a prediction to a user, according to some implementations. The example operation 200 is described as being performed by the system 100 (such as by the one or more processors 130 executing instructions to perform operations associated with the components 140-160). At 202, the system 100 determines a prediction by a first prediction model 140. The first prediction model 140 is associated with a loss function. At 204, the system 100 determines whether the prediction is associated with the first prediction model 140 or the second prediction model 150 based on a joint loss function. The second prediction model is associated with a likelihood function, and the joint loss function is based on the loss function and the likelihood function.

In the above example of the predicted probability distributions for the first prediction model 140 and the second prediction model 150 in light of a Bernoulli variable zᵢ (with zᵢ equal to 1 for the first prediction model 140 and equal to 0 for the second prediction model 150) and based on a Gaussian distribution, the loss function of the first prediction model 140 is the probability density function for a Gaussian distribution, as indicated in equation (1) below:

$$p ( {\hat{y}}_{i} \vert w , {x}_{i} , {z}_{i} = 1 ) = \frac{1}{{σ}_{i} \sqrt{2 π}} {e}^{- \frac{1}{2} {( \frac{{y}_{i} - {μ}_{i}}{{σ}_{i}} )}^{2}} \qquad ( 1 )$$

The likelihood function of the second prediction model 150 is also a probability density function for a Gaussian distribution, as indicated in equation (2) below:

$$p ( {\hat{y}}_{i} \vert w , {x}_{i} , {z}_{i} = 0 ) = \frac{1}{\overline{σ} \sqrt{2 π}} {e}^{- \frac{1}{2} {( \frac{{y}_{i} - \overline{μ}}{\overline{σ}} )}^{2}} \qquad ( 2 )$$

As shown in equation (1), the loss function associated with the first prediction model 140 includes first variables μᵢ and σᵢ that are used to generate a probability (which may be referred to as a confidence) in a prediction \hat{γ}ᵢ from the first prediction model 140. As shown in equation (2), the likelihood function associated with the second prediction model 150 includes second variables μ̅ and σ̅ that are used to generate a probability that the prediction ŷᵢ would be provided by the second prediction model 150 (such as based on the where the prediction lies in the Gaussian distribution defined by the mean and standard deviation). The first variables and the second variables correspond to each other. In other words, the variables between the models are similar types of variables. In the example, both sets of variables include a mean and a standard deviation. Other types of loss functions and likelihood functions may include different variables used to characterize the functions (such as a variance, a median, α values for Quantile regression, or other measurements). With similar types of variables, the loss function and the likelihood function can be combined into a joint loss function that is optimized during training In this manner, the first prediction model 140 and the second prediction model 150 are associated with a joint loss function, and the models may be trained concurrently in optimizing the joint loss function.

A joint loss function (which may also be referred to as a joint likelihood function lᵢ) based on the Bernoulli variable zᵢ is associated with a mutual exclusivity between the prediction being associated with the first prediction model 140 (zᵢ=1) and the prediction being associated with the second prediction model 150 (zᵢ=0). The joint loss function created using the Bernoulli variable zᵢ is indicated in a general form in equation (3) below:

lᵢ=p(ŷᵢ,zᵢ|w,xᵢ)=p(ŷᵢ,zᵢ=1|w,xᵢ)+p(ŷᵢ,zᵢ=0|w,xᵢ) (3)

The joint loss function indicates the combined probabilities of the prediction if the first prediction model 140 is selected and if the second prediction model 150 is selected as being associated with the prediction. p(ŷᵢ=a|w,xᵢ) for a∈{0,1} can be expanded into a multiplication or dot product of the probability of the Bernoulli variable being a for w and xᵢ and the probability of the prediction being ŷᵢ for w,xᵢ as indicated in equation (4) below:

p(ŷᵢ,zᵢ=a|w,xᵢ)=p(\hat{z}ᵢ=a|w,xᵢ)·p(ŷᵢ|w,xᵢ,zᵢ=a) (4)

Using equation (4), lᵢ in equation (3) can be expanded into the form indicated in equation (5) below:

lᵢ=p(\hat{z}ᵢ=1|w,xᵢ)·p(ŷᵢ|w,xᵢ,zᵢ=1)+p(zᵢ=0|w,xᵢ)·p(ŷᵢ|w,xᵢ,zᵢ=0) (5)

Since equation (5) of the joint loss function is in a general form, the equation may be used for any noise model to determine a joint loss function for two prediction models. If three or more prediction models are to be used, equation (4) may be used to expand equation (5) for the desired number of prediction models. Referring back to equation (5) for two prediction models 140 and 150 for training the first prediction model 140 and the second prediction model 150, the joint loss function is optimized (which is described below with reference to FIG. 3). The probability lᵢ is for given xᵢ for integer i. The total probability/likelihood L for a prediction ŷ across all i from 1 to N in the input data is defined as the product of all lᵢ for i from 1 to N, as indicated in equation (6) below:

L:=Πᵢ₌₁^{N}lᵢ (6)

Equation (6) of the total likelihood function is also in a general form, and the equation may be used for any specific joint loss function to determine a total likelihood function.

Referring back to 204 in FIG. 2, determining whether the prediction is associated with the first prediction model 140 or the second prediction model 150 may include determining the probability p(zᵢ=1|w,xᵢ) (also referred to as θᵢ). In some implementations, the system 100 (using the selection model 160) determines that the prediction is associated with the first prediction model 140 if θᵢ is greater than a threshold, and the system 100 determines that the prediction is associated with the second prediction model 140 if θᵢ is less than the threshold. In some implementations, different thresholds are associated with the first prediction model 140 and the second prediction model 150. In this manner, θᵢ between a lower threshold associated with the second prediction model 150 and an upper threshold associated with the first prediction model 140 may indicate that the system 100 is fuzzy in selecting either prediction model. In other words, as θᵢ approaches ½, the prediction may be as easily associated with the second prediction model 150 as with the first prediction model 140. In this manner, determining which prediction model to which the prediction is associated is based on the joint loss function.

At 206, in response to determining that the prediction is associated with the first prediction model 140 (such as θᵢ being greater than a threshold), the system 100 indicates the prediction to a user (such as via the interface 110). In some implementations, if the system 100 determines that the prediction is associated with the second prediction model 150, the system 100 prevents indicating the prediction to the user. In this manner, the system 100 filters which predictions from the first prediction model 140 are presented to the user based on whether the prediction is attributed to the first prediction model of interest to the user. In addition or to the alternative, the system 100 may indicate that a prediction is filtered or any other suitable indication that the prediction is not associated with the first prediction model 140.

While not shown, determining whether the prediction is indicated to a user is based on the confidence in the prediction. For example, if a total likelihood L in the prediction is less than a threshold, the prediction is not indicated to the user. In some other examples, the indication of the prediction may be accompanied with an indication of the confidence or otherwise indicate the confidence in the prediction. As a result, predictions with a low confidence are not presented to the user or are explained to the user to understand the low confidence.

Before the prediction models 140 and 150 are used by the system 100 to predict future cash flow (or any other suitable metrics) and the selection model 160 is used in determining whether the predicted cash flow is to be indicated to the user, the prediction models 140 and 150 are trained using a training set of data (such as historic transaction data and measured cash flow). In typical training of a prediction model, the variables of the loss function are tuned over epochs of the training data to minimize the overall loss for predictions. As used herein, minimizing a loss function refers to reducing the output of the loss function over epochs of the training data. If the output is not reduced by more than a threshold over a consecutive number of epochs, the loss function may be determined to be minimized using the latest variables determined for the loss function. In one example, the Adam training model may be used to optimize a loss function.

If training of the models 140 and 150 would be performed independent of each other, the one or more first variables are not determined with reference to the one or more second variables (and vice versa). In addition, training of a Bernoulli variable in optimizing a joint loss function would not occur. As a result, the predictions from one prediction model may not correlate to predictions from the other model. In some implementations, the first prediction model 140 and the second prediction model 150 are trained concurrently by optimizing a joint loss function. As noted above, the joint loss function includes the one or more first variables from the loss function associated with the first prediction model 140 and the one or more second variables from the likelihood function associated with the second prediction model 150. In optimizing the joint loss function, the one or more first variables and the one or more second variables are determined with reference to each other to optimize the overall output from the joint loss function. In addition, the Bernoulli variables across the training dataset points are determined to optimize the overall output from the joint loss function. In this manner, predictions from the models that are trained concurrently correlate to each other.

With the joint loss function being based on a Bernoulli variable (such as zᵢ in equation (5) above to determine lᵢ, which is used to determine total likelihood L in equation (6) above), optimizing the joint loss function includes determining the one or more first variables and the one or more second variables to: (i) increase the output of the total likelihood function (with the total likelihood indicating a confidence in the prediction) and (ii) adjust p(zᵢ=1|w,xᵢ) in the total likelihood function towards 0 or 1 (and away from ½). In this manner, the Bernoulli variable may be trained in optimizing the joint loss function. In some implementations, increasing the output of the total likelihood function may include minimizing the negative log likelihood function for the total likelihood (as described below).

FIG. 3 shows an illustrative flowchart depicting an example operation 300 for training prediction models used in determining a prediction, according to some implementations. The prediction models to be trained in describing the example operation 300 include the first prediction model 140 and the second prediction model 150 of the system 100 in FIG. 1. The training may be performed by the system 100 or may be performed by another suitable system or device (with the trained models being provided to the system 100 via the interface 110). The operation 300 is described by being performed by the system 100 in the below examples exclusively for clarity in describing the operation.

At 302, the system 100 obtains a loss function associated with the first prediction model 140 (with the loss function including one or more first variables). At 304, the system 100 obtains a likelihood function associated with the second prediction model 150 (with the likelihood function including one or more second variables). At 306, the system 100 determines a joint loss function based on the loss function and the likelihood function. In some implementations, the joint loss function is determined using equations (5) and (6) above and is provided to the system 100 for training the prediction models 140 and 150. In some other implementations, the system 100 generates the joint loss function based on equations (5) and (6) above. As noted above in equation (5), determining the joint loss function may include combining the loss function and the likelihood function into a single function based on a Bernoulli variable (308). The single function indicates a variance of the first data point from a probability distribution associated with the second prediction model 150. With the Bernoulli variable, θᵢ approaching 1 indicates that the variance is increasing, and θᵢ approaching 0 indicates that the variance is decreasing. In this manner, the joint loss function is associated with a mutual exclusivity between the first data point as the prediction and the second data point as the prediction, and outputs of the joint loss function (such as corresponding to a total likelihood) may be used in selecting either the first prediction model 140 or the second prediction model 150 as being associated with the prediction (not both).

At 310, the system 100 optimizes the joint loss function to concurrently train the first prediction model 140 and the second prediction model 150. Optimizing the joint loss function may also include training the Bernoulli variable as to when the variable is 0 and when the variable is 1 (or other values if more than two prediction models) for the training set of data. In some implementations, optimizing the joint loss function includes applying a training set of data to the first prediction model 140 and to the second prediction model 150 to generate values for the one or more first variables and the one or more second variables of the joint loss function (312). In the above example of the first variables and the second variables including means and standard deviations, the system 100 determines the means and standard deviations to optimize the joint loss function so that the total likelihood increases. For example, the system 100 determines the means and standard deviations to minimize a negative log likelihood function based on total likelihood.

A specific example of determining the joint loss function and optimizing the joint loss function is provided below with reference to the noise being modeled as a Gaussian distribution and the second prediction model 150 being defined as a Gaussian distribution (as described with reference to equations (1) and (2) above). The specific example is provided for clarity in explaining aspects of the joint loss function (and total likelihood function). It is apparent from the below example that the steps may be performed for any joint loss function determined for any suitable first prediction model 140 and second prediction model 150.

In some implementations, optimizing the joint loss function includes minimizing the negative log likelihood function for the total likelihood L. The negative log likelihood (−log(L)) based on equation (6) above is indicated in a general form in equation (7) below:

−log(L)=−log(Πᵢ₌₁^{N}lᵢ)=−Σᵢ₌₁^{N} log lᵢ (7)

In the example, an output of the predicted probability distribution p(ŷᵢ|w,xᵢ,zᵢ=1) includes variables [μᵢ(xᵢ,w),σᵢ (xᵢ,w),θᵢ(w,xᵢ)] (with θᵢ being a notation of p(zᵢ=1|w,xᵢ) indicating the probability that the first prediction model 140 is selected), and the predicted probability distribution p(ŷᵢ|w,xᵢ,zᵢ=1) is assumed to follow a Gaussian distribution N(μᵢ(xᵢ,w),σᵢ(xᵢ,w)). With the above assumptions, the joint loss function for lᵢ (indicated in a general form in equation (5) above) is defined for the specific example in equation (8) below:

lᵢ=p(\hat{z}ᵢ=1|w,xᵢ)·p(ŷᵢ|w,xᵢ,zᵢ=1)+p(zᵢ=0|w,xᵢ)·p(ŷᵢ|w,xᵢ,zᵢ=0) (8)

Replacing p(zᵢ=1|w,xᵢ) and p(zᵢ=0|w,xᵢ) with the θᵢ and 1−θᵢ notation, respectively (since the sum of the probabilities equals 1), yields equation (9) below:

lᵢ=θᵢ·p(ŷᵢ|w,xᵢ,zᵢ=1)+(1−θᵢ)·p(ŷᵢ|w,xᵢ,zᵢ=0) (9)

For the example, substituting p(ŷᵢ|w,xᵢ,zᵢ=1) and p(ŷᵢ|w,xᵢ,zᵢ=0) with the terms from equations (1) and (2) above, respectively, yields equation (10) below:

$${l}_{i} = {θ}_{i} \cdot \frac{1}{{σ}_{i} \sqrt{2 π}} {e}^{- \frac{1}{2} {( \frac{{y}_{i} - {μ}_{i}}{{σ}_{i}} )}^{2}} + ( 1 - {θ}_{i} ) \cdot \frac{1}{\overline{σ} \sqrt{2 π}} {e}^{- \frac{1}{2} {( \frac{{y}_{i} - \overline{μ}}{\overline{σ}} )}^{2}} \qquad ( 10 )$$

Equation (10) can be rewritten as equation (11) below:

$${l}_{i} = \frac{{θ}_{i}}{{σ}_{i} \sqrt{2 π}} \cdot {e}^{- \frac{1}{2} {( \frac{{y}_{i} - {μ}_{i}}{{σ}_{i}} )}^{2}} ( 1 + \frac{( 1 - {θ}_{i} ) {σ}_{i}}{{θ}_{i} \overline{σ}} \cdot {e}^{\frac{1}{2 {σ}_{i}^{2}} {( {y}_{i} - {μ}_{i} )}^{2} - \frac{1}{2 {\overline{σ}}^{2}} {( {y}_{i} - \overline{μ} )}^{2}} ) \qquad ( 11 )$$

For the joint loss function in equation (11), the total likelihood L is defined as in equation (12) below:

$$L := {\prod }_{i = 1}^{N} ( \frac{{θ}_{i}}{{σ}_{i} \sqrt{2 π}} \cdot {e}^{- \frac{1}{2} {( \frac{{y}_{i} - {μ}_{i}}{{σ}_{i}} )}^{2}} ( 1 + \frac{( 1 - {θ}_{i} ) {σ}_{i}}{{θ}_{i} \overline{σ}} \cdot {e}^{\frac{1}{2 {σ}_{i}^{2}} {( {y}_{i} - {μ}_{i} )}^{2} - \frac{1}{2 {\overline{σ}}^{2}} {( {y}_{i} - \overline{μ} )}^{2}} ) ) \qquad ( 12 )$$

As noted above, optimizing the joint loss function may include increasing the total likelihood L, such as minimizing the negative log likelihood function −log(L). The log likelihood function based on L in equation (12) is provided in equation (13) below:

$$log ( L ) = - {\sum }_{i = 1}^{N} ( \frac{{( {y}_{i} - {μ}_{i} )}^{2}}{2 {σ}_{i}^{2}} + log ( \frac{{σ}_{i}}{{θ}_{i}} ) - log ( 1 + \frac{1 - {θ}_{i}}{{θ}_{i}} \cdot \frac{{σ}_{i}}{\overline{σ}} \cdot {e}^{\frac{1}{2 {σ}_{i}^{2}} {( {y}_{i} - {μ}_{i} )}^{2} - \frac{1}{2 {\overline{σ}}^{2}} {( {y}_{i} - \overline{μ} )}^{2}} ) ) - N log \sqrt{2 π} \qquad ( 13 )$$

As shown in equation (13), the two overall terms of the log likelihood function are written to be expressed as negative terms (with both including a minus sign). In this manner, the negative log likelihood function to be minimized in training the first prediction model 140 and the second prediction model 150 for the specific example is provided in equation (14) below:

$$- log ( L ) = {\sum }_{i = 1}^{N} ( \frac{{( {y}_{i} - {μ}_{i} )}^{2}}{2 {σ}_{i}^{2}} + log ( \frac{{σ}_{i}}{{θ}_{i}} ) - log ( 1 + \frac{1 - {θ}_{i}}{{θ}_{i}} \cdot \frac{{σ}_{i}}{\overline{σ}} \cdot {e}^{\frac{1}{2 {σ}_{ι}^{2}} {( {y}_{i} - {μ}_{i} )}^{2} - \frac{1}{2 {\overline{σ}}^{2}} {( {y}_{i} - \overline{μ} )}^{2}} ) ) + N log \sqrt{2 π} \qquad ( 14 )$$

While it is noted that training the prediction models may include determining the one or more first values and the one or more second values to minimize the negative log likelihood function, the one or more first values and the one or more second values may also be determined to ensure that p(zᵢ=1|w,xᵢ) (also referred to as θᵢ) is towards 0 or 1 instead of ½. If θᵢ approaches ½ instead of 0 or 1, there is a fuzziness in selecting either the first prediction model or the second prediction model for the prediction. In other words, a probability of ½ indicates that the system 100 is just as likely to pick one prediction model over the other.

In some implementations, another term is added to the joint loss function to prevent such fuzziness. The term causes the probability to shift towards 0 or 1. An example term may include

$${( {θ}_{i} - \frac{1}{2} )}^{2} or \vert {θ}_{i} - \frac{1}{2} \vert .$$

The term may be accompanied with a tunable parameter λ and combined with the combined loss function and the likelihood function. For the specific example of a joint loss function in equation (11) above, the term (with the tunable parameter λ) may be added to the joint loss function, such as indicated in equation (15) below:

$${l}_{i} + λ * \vert {θ}_{i} - \frac{1}{2} \vert = \frac{{θ}_{i}}{{σ}_{i} \sqrt{2 π}} \cdot {e}^{- \frac{1}{2} {( \frac{{y}_{i} - {μ}_{i}}{{σ}_{i}} )}^{2}} ( 1 + \frac{( 1 - {θ}_{i} ) {σ}_{i}}{{θ}_{i} \overline{σ}} \cdot {e}^{\frac{1}{2 {σ}_{t}^{2}} {( {y}_{i} - {μ}_{i} )}^{2} - \frac{1}{2 {\overline{σ}}^{2}} {( {y}_{i} - \overline{μ} )}^{2}} ) + λ * \vert {θ}_{i} - \frac{1}{2} \vert \qquad ( 15 )$$

The total likelihood L based on lᵢ is the same as described above. In this manner, the log likelihood may be the same as in equation (13) above). A sum of the additional term across all i (such as λ*Σᵢ₌₁^{N}|θᵢ−½|) may be added to the log likelihood function (such as to equation (13)). In this manner, the function to be minimized (such as based on a negative log likelihood in equation (14) with the constant N log \sqrt{2π} removed) is provided in equation (16) below:

$${min}_{w} [ {\sum }_{i = 1}^{N} ( \frac{{( {y}_{i} - {μ}_{i} )}^{2}}{2 {σ}_{i}^{2}} + log ( \frac{{σ}_{i}}{{θ}_{i}} ) - log ( 1 + \frac{1 - {θ}_{i}}{{θ}_{i}} \cdot \frac{{σ}_{i}}{\overline{σ}} \cdot {e}^{\frac{1}{2 {σ}_{i}^{2}} {( {y}_{i} - {μ}_{i} )}^{2} - \frac{1}{2 {\overline{σ}}^{2}} {( {y}_{i} - \overline{μ} )}^{2}} ) ) - λ * {\sum }_{i = 1}^{N} \vert {θ}_{i} - \frac{1}{2} \vert ] ∀ {θ}_{i} , 0 \leq {θ}_{i} \leq 1 \qquad ( 16 )$$

Equation (16) is a joint optimization problem regarding the set of first variables and second variables and regarding the probabilities θᵢ. In this manner, optimizing the joint loss function by minimizing the function in equation (16) is in consideration of adjusting θᵢ away from ½ to prevent fuzziness in determining which prediction model.

As described above, a system is configured to filter which predictions are to be indicated to a user and indicating such predictions to a user. The predictions that are indicated to a user are determined by a first prediction model and then compared to a second prediction model to determine a variance of the prediction from the second prediction model. Operations in indicating a prediction to a user and preventing an indication of a prediction to the user based on a joint loss function, training the models based on optimizing the joint loss function, and other suitable operations are described in the above examples for explaining aspects of the present disclosure.

As used herein, a phrase referring to “at least one of” a list of items refers to any combination of those items, including single members. As an example, “at least one of: a, b, or c” is intended to cover: a, b, c, a-b, a-c, b-c, and a-b-c.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor or any conventional processor, controller, microcontroller, or state machine. A processor also may be implemented as a combination of computing devices such as, for example, a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

What is claimed is:

1. A computer-implemented method for indicating a prediction to a user, comprising:
determining a prediction by a first prediction model, wherein the first prediction model is associated with a loss function;
determining whether the prediction is associated with the first prediction model or a second prediction model based on a joint loss function, wherein:
the second prediction model is associated with a likelihood function; and
the joint loss function is based on the loss function and the likelihood function; and
in response to determining that the prediction is associated with the first prediction model, indicating the prediction to the user.

2. The method of claim 1, further comprising:
in response to determining that the prediction is associated with the second prediction model, preventing the prediction from being indicated to the user.

3. The method of claim 2, wherein the joint loss function is determined by combining the loss function associated with the first prediction model and the likelihood function associated with the second prediction model into a single function to indicate a variance of the prediction with reference to the second prediction model, wherein:
the loss function includes one or more first variables;
the likelihood function is defined by one or more second variables corresponding to the one or more first variables;
the joint loss function includes the one or more first variables and the one or more second variables; and
the joint loss function is associated with mutual exclusivity between the prediction being associated with the first prediction model and being associated with the second prediction model.

4. The method of claim 3, wherein the first prediction model and the second prediction model are trained concurrently by optimizing the joint loss function.

5. The method of claim 4, wherein optimizing the joint loss function includes:
applying a training set of data to the first prediction model and to the second prediction model; and
generating the one or more first variables and the one or more second variables in response to applying the training set of data to optimize the joint loss function.

6. The method of claim 5, wherein determining the joint loss function further includes combining a tunable variable with the combined loss function and likelihood function to prevent fuzziness in determining whether the prediction is associated with the first prediction model or with the second prediction model.

7. The method of claim 6, wherein optimizing the joint loss function further includes adjusting the tunable variable to adjust a probability that the prediction is associated with the first prediction model away from ½.

8. The method of claim 1, wherein the first prediction model includes a machine learning model.

9. The method of claim 8, wherein the second prediction model is based on a parametric distribution function.

10. The method of claim 9, wherein indicating the prediction to the user includes indicating that the prediction varies from a probability distribution associated with the parametric distribution function.

11. The method of claim 9, wherein:
the parametric distribution function is a Gaussian distribution;
the likelihood function is a probability distribution function for a Gaussian distribution defined by a mean and a standard deviation;
the loss function includes means and standard deviations;
the joint loss function includes the mean and the standard deviation from the likelihood function and the means and standard deviations from the loss function; and
the joint loss function is associated with a negative log likelihood function to be minimized in optimizing the joint loss function.

12. The method of claim 8, wherein the second prediction model is based on one or more quantiles for a range of output data from a training set of data.

13. The method of claim 1, wherein the prediction is to predict future cash flow based on financial transaction input data to the first prediction model and the second prediction model.

14. A system for indicating a prediction to a user, comprising:
one or more processors; and
a memory coupled to the one or more processors and storing instructions that, when executed by the one or more processors, cause the system to perform operations comprising:
determining a prediction by a first prediction model, wherein the first prediction model is associated with a loss function;
determining whether the prediction is associated with the first prediction model or a second prediction model based on a joint loss function, wherein:
the second prediction model is associated with a likelihood function; and
the joint loss function is based on the loss function and the likelihood function; and
in response to determining that the prediction is associated with the first prediction model, indicating the prediction to the user.

15. The system of claim 14, wherein execution of the instructions further causes the system to perform the operations further comprising:
in response to determining that the prediction is associated with the second prediction model, preventing the prediction from being indicated to the user.

16. The system of claim 15, wherein the joint loss function is determined by combining the loss function associated with the first prediction model and the likelihood function associated with the second prediction model into a single function to indicate a variance of the prediction with reference to the second prediction model, wherein:
the loss function includes one or more first variables;
the likelihood function is defined by one or more second variables corresponding to the one or more first variables;
the joint loss function includes the one or more first variables and the one or more second variables; and
the joint loss function is associated with mutual exclusivity between the prediction being associated with the first prediction model and being associated with the second prediction model.

17. The system of claim 16, wherein the first prediction model and the second prediction model are trained concurrently by optimizing the joint loss function.

18. The system of claim 17, wherein optimizing the joint loss function includes:
applying a training set of data to the first prediction model and to the second prediction model; and
generating the one or more first variables and the one or more second variables in response to applying the training set of data to optimize the joint loss function.

19. The system of claim 18, wherein:
determining the joint loss function further includes combining a tunable variable with the combined loss function and likelihood function to prevent fuzziness in determining whether the first data point or the second data point is to be used as the prediction; and
optimizing the joint loss function further includes adjusting the tunable variable to adjust a probability that the prediction is associated with the first prediction model away from ½.

20. A system for indicating a future cash flow prediction of a business to a user, comprising:
one or more processors; and
a memory coupled to the one or more processors and storing instructions that, when executed by the one or more processors, cause the system to perform operations comprising:
determining a prediction of future cash flow by a first prediction model based on, wherein the first prediction model is associated with a loss function;
determining whether the prediction is associated with the first prediction model or a second prediction model based on a joint loss function, wherein:
the second prediction model is associated with a likelihood function; and
the joint loss function is based on the loss function and the likelihood function;
in response to determining that the prediction is associated with the first prediction model, indicating the prediction to the user; and
in response to determining that the prediction is associated with the second prediction model, preventing the prediction from being indicated to the user.
